(19) United States
(12) Patent Application Publication
(10) Pub. No.: US 2003/0184025 A1
(43) Pub. Date: Oct. 2, 2003

(54) Gasket

(76) Inventor: Katsunori Matsuki, Okayama (JP)

Correspondence Address: WENDEROTH, LIND & PONACK, L.L.P., 2033 K STREET N. W., SUITE 800, WASHINGTON, DC, 20006-1021, US

(21) Appl. No.: 10/401,882

(22) Filed: Mar. 31, 2003

(30) Foreign Application Priority Data
Mar. 29, 2002 (JP) 2002-094167

(51) Int. Cl. F02F 11/00

(52) U.S. Cl. 277/591

(57) ABSTRACT

A gasket which is mounted onto a groove knurled on the seal surface of a cover member and is used for sealing between the cover member and a block member closely attached to the seal surface of the cover member, wherein the gasket has at least one satin finished surface portion on its side wall.

### BACKGROUND OF THE INVENTION

1. Field of the Invention

The present invention relates to a sealing member (for example, a gasket) which seals between a cover member (for example, a cylinder head cover) in an engine mounted on a motor vehicle or the like and a corresponding member (for example, a cylinder head). Particularly, the present invention relates to an improvement of the mounting operability for attaching a gasket to an annular groove knurled in the cover member.

2. Description of the Related Art

Conventionally a sealing member (for example, a gasket), which seals between a cover member such as a head cover, an intake manifold, and the like of an engine mounted on a motor vehicle or the like, and a block member such as a cylinder head, a cylinder block, and the like, employs an annular gasket formed from an elastic material such as synthetic rubber, cork, synthetic resin, and the like and has a rectangular or round cross sectional shape.

When the conventionally used gasket is inserted into the annular groove knurled on a seal surface of the cover member from the leading end side at the time of being mounted, the bottom surface side of the gasket opposing to the leading end side is exposed from the annular groove in a state in which most portions thereof are attached within the annular groove.

The corresponding member, such as the cylinder head or the like, is in contact with the exposed bottom portion.

In this case, when fastening the cover member and the corresponding member using a fastening device such as a bolt or the like at the time of fastening, the gasket is compressed, and is elastically deformed so as to be closely and strongly attached to each other, whereby the required sealing operation is complete. This fastening is generally performed with a fastening torque of about 5 to 10 N·m.

However, the conventionally used annular gasket mentioned above cannot respond to requirements such as a safety attachment at the time of being mounted, which would prevent the gasket from falling down at the time of being fastened and the like, in an assembly operation.

That is, corresponding to a recent weight saving requirement, the gasket is structured such that it is formed into an O-ring shape having a narrow and vertically long cross section. When it is intended to attach a gasket formed in this manner to the annular groove knurled on the seal surface of the cover member, it is difficult to rapidly and securely attach the gasket to the annular groove knurled in the cover member because of the narrow shape.

Furthermore, the gasket, which is attached to the annular groove knurled on the seal surface of the cover member and is formed in the O-ring shape having the narrow and vertically long cross section mentioned above, is easily deformed in the outer portion of the annular groove and easily falls down into a transverse position in order to be fastened, at time of being fastened, because of its vertically long shape.

Furthermore, in an engine assembly line, after the gasket is mounted to the cover member, the cover member is reversed, and the fastening step mentioned above to the cylinder head or the like is performed. Then, in the case that the dropout prevention means provided in the gasket is insufficient, there is a possibility that any problems, such as a seal detect caused by a dropout or displacement of the gasket, may be generated. In addition, a more serious breakage may be sometimes generated due to the dropout or displacement of the gasket.

On the contrary, when a dropout prevention means provided on the gasket, for example, a projecting portion arranged on a side wall of the gasket, is made large, the characteristics of insertion into the annular groove are deteriorated.

Therefore, a gasket structure is required, which is suitable for a work, so that it can be rapidly and easily mounted onto the annular groove provided onto the seal surface of the cover member as well as securely mounted onto said annual groove.

In recent engine assembly lines, there has even been generated a requirement for automatically attaching the gasket to the annular groove knurled in the cover member by use of a mounting robot or the like, in further advance of the matter mentioned above.

However, since the gasket having the narrow cross section mentioned above and formed in the vertical O-ring shape is inferior in a shape maintaining property, the said gasket cannot be applied to automatic attachment, which is performed in recent engine assembly lines as mentioned above.

### SUMMARY OF THE INVENTION

Taking the defects mentioned above into consideration, the object of the present invention is to provide a gasket that has an increased sealing performance, and that is suitable for a work so that it can be rapidly and easily mounted onto a groove knurled on the seal surface of the cover member as well as securely mounted onto said groove.

In order to solve the problems mentioned above, one aspect of the present invention provides a gasket, especially an elastic gasket, which is mounted onto a groove knurled on a seal surface of a cover member and is used for sealing between a cover member and a block member closely attached to a seal surface of the cover member, wherein the gasket has at least one satin finished surface portion on its side wall.

Another aspect of the present invention provides a gasket, wherein the gasket has at least one projecting portion provided on its side wall, and a satin finished surface portion is formed on the surface of said projecting portion.

Still another aspect of the present invention provides a gasket, wherein the gasket has at least one corner portion, and a satin finished surface portion is formed on the surface of said corner portion.

Still another aspect of the present invention provides a gasket, wherein the gasket has at least one arch portion, and a satin finished surface portion is formed on the surface of the base portion in the rising portion of said arch portion.

In the before described gasket of the present invention, the gasket is molded using a metal mold cavity used for molding gaskets having at least one rough surface portion, formed by a surface roughening process, on its inner wall surface.

In accordance with the present invention, the satin finished surface portion or portions are formed op a part or on some parts of the side wall of the gasket. Since this satin finished surface portion has a small frictional force, it is possible to smoothly and safely insert the gasket into the groove under applied pressure and mount the gasket onto the annular groove knurled on the seal surface of the cover member. Furthermore, when a gasket of the present invention has been mounted onto the groove, it transmits its rebound resilience directly to the groove in a static state and does not generate slack although the satin finished surface portion, which has a small frictional force, is provided. So, it is possible to achieve sufficient fixing force and seal performance.

In the gasket, in accordance with the present invention, the satin finished surface portion is provided on the side surface of the gasket as mentioned above. Accordingly, when inserting and mounting the gasket to the annular groove of the cover member, the satin finished surface portion performs a guiding function, thereby making it possible to very smoothly insert the gasket into the groove, so that it is possible to remove the risk of an imperfect mounting.

Accordingly, when using the gasket of the present invention, it is possible to employ a robot for automatic mounting operations or the like in engine assembly lines.

### BRIEF DESCRIPTION OF THE DRAWINGS

FIG. 1 is a perspective view that shows the embodiment of a gasket in accordance with the present invention; and

FIG. 2 is a cross sectional view that shows an example of the fastening process between a cover member and a corresponding member in which the gasket of the present invention is mounted onto the groove of the cover member.

### DESCRIPTION OF PREFERRED EMBODIMENTS

A description will be given below of a preferable embodiment in accordance with the present invention with reference to the accompanying drawings.

A gasket 3 of the present invention is attached to (mounted onto) a groove portion 11 (for example, an annular groove) knurled on the seal surface of a cover member 1 (for example, a cylinder head cover) in an engine or the like for a motor vehicle, as shown in FIG. 2. This gasket 3 is used for sealing between a cover member 1 and a block member 2 such as a cylinder head or a cylinder block closely attached to the seal surface of the cover member 1.

The gasket 3 is formed from an elastic material, for example, a synthetic rubber material, a synthetic resin material or the like, in accordance with the conventionally known manner. The material for the gasket 3 used here includes, for example, a rubber material, a thermosetting elastomer, a resin material or the like. As the rubber material, it is possible to employ a butyl rubber, a styrene-butadiene copolymer, an ethylene-vinyl acetate copolymer, an ethylene-methylacrylate copolymer, an ethylene-ethyl acrylate copolymer, a butadiene rubber, a nitrile rubber, a hydrogenation nitrile rubber, an acrylic rubber, a silicon rubber, a fluorine-contained rubber, a phlorosilicon rubber, an ethylene propylene rubber, and the like.

The gasket 3 of the present invention can be formed by employing the material as mentioned above and using a metal mold cavity for molding gaskets having at least one rough surface portion on an inner wall surface of said metal mold cavity. The previously described rough surface portion can be formed by any surface roughening process.

That is to say, although it is not shown, the before described metal mold cavity for molding a gasket is structured such that the surface roughening process is applied to the desired portion or portions on the inner wall surface of said metal mold cavity by a shot blast, a peening process, a knurling process or the like. The rough surface portion is formed on a part of or some parts of the inner wall surface of said metal mold cavity for molding gaskets.

When forming the gasket 3 of the present invention by using the before described metal mold cavity for molding gaskets, the rough surface portion or portions formed on the inner wall surface of the metal mold cavity are mapped onto the side wall of the molded gasket 3. Whereby the satin finished surface portion or portions are formed on the side wall of the gasket 3 by mapping the rough surface portion or portions of the metal mold cavity.

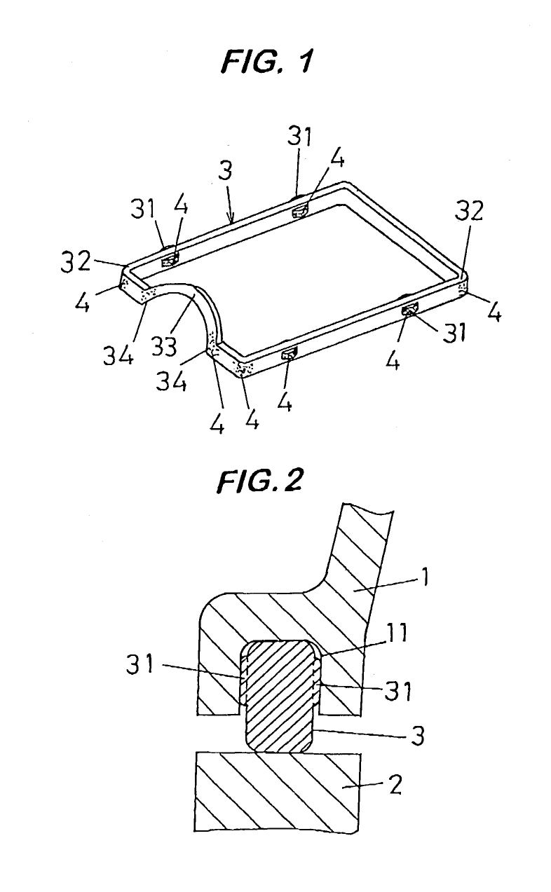

The gasket 3, in accordance with the present invention, can be modified to a configuration in which one or a plurality of projecting portions 31 are provided on the side wall. In the embodiment illustrated in FIG. 1, the projecting portions 31 are arranged in four portions.

Furthermore, the gasket 3, in accordance with the present invention, can be modified to a configuration in which one or a plurality of corner portions 32 are provided. In the embodiment illustrated in FIG. 1, the corner portions are arranged in four portions.

Furthermore, the gasket 3, in accordance with the present invention, can be modified to a configuration in which an arch portion 33 is provided. In the embodiment illustrated in FIG. 1, one arch portion 33 curved toward a center direction of the annular gasket 3 is formed.

The projecting portion 31, arranged in the side wall of the gasket 3, is provided for the purpose of preventing the gasket from dropping out. So, it is formed slightly wider than the annular groove 11 of the cover member 1, as illustrated in FIG. 2, in order to apply a rebound resilience. Accordingly, the structure is made such that it is hard for the gasket 3, inserted under any applied pressure and attached to (mounted onto) the annular groove 11 of the cover member 1, to drop out.

Therefore, it is not easy to insert and attach the portion in which the projecting portion 31 is arranged on the side wall of the gasket 3 onto the annular groove 11. That is, in the position in which the projecting portion 31 is arranged on the side wall of the gasket 3, a high insertion resistance may be provided when the gasket 3 is inserted into the annular groove 11 of the cover member 1 under applied pressure.

Also, there is a possibility that a high insertion resistance may be caused at the corner portion 32 of the gasket 3 due to any elongation or contraction, generated in accordance with the fitting state of portions other than the corner portion 32.

Furthermore, in the base portion 34 of the rising portion in the arch portion 33, there is a possibility that a high insertion resistance may be caused in the same manner.

The gasket 3, in accordance with the present invention, is formed, as mentioned above, using a metal mold cavity for molding gaskets in which the rough surface portion or portions are formed on a part or some parts of the inner wall surface of said metal mold cavity. The rough surface portions can be previously formed on the inner wall surface of the metal mold cavity in correspondence to the positions in which the projecting portions 31, the corner portions 32, and the base portions 34 of the rising portions in the arch portion 33 are formed on the gasket 3 after it is formed. If the metal mold cavity is formed as the before describe, the rough surface portions are mapped, and the satin finished surface portions 4 can be formed on the surfaces of the projecting portions 31, the corner portions 32, and the base portions 34 of the rising portions in the arch portion 33 that are provided in the gasket 3 after it is formed.

In the portions in which the satin finished surface portions 4 are formed, a frictional force at a time of inserting the gasket 3 into the annular groove 11 of the cover member 1 is reduced, and the insertion resistance under applied pressure becomes small.

Then, by employing the gasket 3 in which the satin finished surface portions 4 are formed on the surface of the projecting portions 31, the corner portions 32, and the base portions 34 of the rising portions in the arch portion 33, which particularly have a high insertion resistance as previously described, it is possible to decrease the insertion resistance under applied pressure at the time of inserting the gasket 3 into the annular groove 11 of the cover member 1. Thereby, it is possible to achieve a smooth, stable, and safe attachment and mounting.

In the gasket of the present invention, there is a situation when the projecting portion 31 arranged on the side wall of the gasket 3 may be provided for the purpose of preventing the gasket from falling down despite the main purpose of preventing the gasket from dropping out. The projecting 31 arranged for the purpose of preventing the gasket from falling down is generally smaller than the projecting 31 arranged for the purpose of preventing the gasket from dropping out. If a satin finished surface portion 4 is provided on the surface of the projecting portion 31 provided for the purpose of preventing the gasket from falling down, it is still possible to decrease the insertion resistance at a time of inserting the gasket 3 under applied pressure to the annular groove 11 of the cover member 1, and it is possible to achieve smooth, stable, and safe attachment and mounting.

The satin finished surface portion 4 in the gasket 3 of the present invention is basically provided in the portion in which the insertion resistance at the time of inserting the gasket 3 into the annular groove 11 of the cover member 1 under applied pressure is relatively large. Accordingly, for example, in an irregular shaped gasket or a modified shaped gasket (not shown) or the like, it goes without saying that the satin finished surface portion 4 is arranged not only on the surfaces of the projecting portions 31, the corner portions 32, and the base portions 34 of the rising portions in the arch portion 33 mentioned above, but also any portions having a high insertion resistance.

Although the preferred embodiment of the present invention is described above using the attached figures, it is to be understood that the invention is not limited to the forms disclosed in the previously described embodiment, and various modifications and variations may be made within the technical scope of the invention as set forth in the appended claims.

What is claimed is:

1. A gasket which is mounted onto a groove knurled on a seal surface of a cover member and is used for sealing between the cover member and a block member closely attached to the seal surface of the cover member,
wherein the gasket has at least one satin finished surface portion on its side wall.

2. The gasket according to claim 1, wherein the gasket has at least one projecting portion provided on its side wall, and the satin finished surface portion is formed on a surface of said projecting portion.

3. The gasket according to claim 1, wherein the gasket has at least one corner portion, and the satin finished surface portion is formed on a surface of said corner portion.

4. The gasket according to claim 1, wherein the gasket has at least one arch portion, and the satin finished surface portion is formed on a surface of the base portion in the rising portion of said arch portion.

5. The gasket according to anyone of claims 1 to 4, wherein it is molded using a metal mold cavity for molding gaskets having at least one rough surface portion, formed by surface roughening process, on its inner wall surface.
